(19) United States
(12) Patent Application Publication
(10) Pub. No.: US 2007/0182937 A1
(43) Pub. Date: Aug. 9, 2007

(54) REAR PROJECTION DISPLAY APPARATUS AND IMAGE ADJUSTING METHOD THEREOF

(75) Inventors: Chu-Ming Cheng, Hsinchu (TW); Sung-Nan Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: YOUNG OPTICS INC., Hsinchu (TW)

(21) Appl. No.: 11/564,300

(22) Filed: Nov. 29, 2006

(30) Foreign Application Priority Data
Feb. 7, 2006 (TW) 95104018

(51) Int. Cl. G03B 21/22

(52) U.S. Cl. 353/74

(57) ABSTRACT

A rear projection apparatus includes an optical engine, a screen, a projection lens disposed between the screen and the optical engine and a condensing element disposed on the screen and between the screen and the projection lens. The center of condensing element is substantially offset from the center of the screen. The optical engine includes a light source suitable for providing a light beam and a display device suitable for transforming the light beam into an image light beam. The projection lens is disposed on the transmission path of the image light beam and the position of the projection lens is offset from the center of the display device. The optical axis of the projection lens on the screen is offset from the optical axis of the condensing element. The display device has a common plane with a normal vector not parallel to the optical axis of the projection lens.

### CROSS-REFERENCE TO RELATED APPLICATION

This application claims the priority benefit of Taiwan application serial no. 95104018, filed Feb. 7, 2006. All disclosure of the Taiwan application is incorporated herein by reference.

### BACKGROUND OF THE INVENTION

1. Field of the Invention

The present invention relates to a display apparatus. More particularly, the present invention relates to a rear projection display apparatus and an image adjusting method thereof.

2. Description of the Related Art

FIGS. 1A and 1B are diagrams showing image-producing methods for two types of conventional rear projection display apparatus both using a non-offset projection technique. First, as shown in FIG. 1A, a conventional rear projection display apparatus that uses a non-offset projection design has a projection lens 110 with an optical axis 112 aligned with the center of the display device 120. Furthermore, an image light beam projected from the projection lens 110 towards the uppermost end of the screen 130 forms an included angle θ₁ (a field of view) with respect to the optical axis 112. Similarly, the image light beam projected from the projection lens 110 towards the lowermost end of the screen 130 forms an included angle θ₂ (a field of view) with respect to the optical axis 112. Moreover, the angle θ₁ is equal to the angle θ₂ so that the center of the image light beam projected on the image frame of the screen 130 coincides in position to the projection of the optical axis 112 of the projection lens 110 on the screen 130.

In the aforementioned rear projection display apparatus, a considerable distance is maintained between the projection lens 110 and the screen 130 in order to display a large size image. Therefore, this type of rear projection display apparatus has a larger thickness. To trim down the thickness of the rear projection display apparatus, an additional reflective plate 140 (as shown in FIG. 1B) is installed between the projection lens 110 and the screen 130. Although the foregoing method can reduce the thickness of the rear projection display apparatus, the overall trend is to produce a display device with thinner and more streamline body. In other words, the thickness for this type of design is still too large to be accepted.

FIGS. 2A and 2B are diagrams showing the image-producing methods for two types of conventional rear projection display apparatus both using an offset projection technique. First, as shown in FIG. 2A, the conventional rear projection display apparatus that uses an offset projection design has a projection lens 210 with an optical axis 212 offset from the center of the display device 220. Furthermore, the position of the optical axis 212 of the projection lens 210 on the screen 230 matches with the center of a Fresnel lens located above the screen 230. Furthermore, the image light beam projected from the projection lens 210 towards the uppermost end of the screen 230 forms an included angle θ₃ (a field of view) with respect to the optical axis 212. Similarly, the image light beam projected from the projection lens 210 towards the lowermost end of the screen 230 forms an included angle θ₄ (a field of view) with respect to the optical axis 212. Moreover, the angle θ₃ is greater than the angle θ₄ and θ₁ so that the center of the image light beam projected on the image frame of the screen 230 is offset in position to the projection of the optical axis 212 of the projection lens 210 on the screen 230. In addition, a reflective plate 240 (as shown in FIG. 2B) is installed between the projection lens 210 and the screen 230 to reduce overall thickness of the rear projection display apparatus. Compared with the rear projection display apparatus that uses a non-offset projection technique (as shown in FIG. 1B), the rear projection display apparatus that uses an offset projection technique (as shown in FIG. 2B) produces a substantial reduction in body thickness that matches the demand for a slimmer body.

Although the offset projection technique can reduce the body thickness of the rear projection display apparatus, the field of view (for example, θ₃) is increased. Moreover, in the design of the projection lens, the light beam is more likely to produce image distortion if the field of view is larger. As a result, the displayed image 50 will produce severe keystone-like distortion as shown in FIG. 3. To prevent such undesirable distortion, a number of additional lenses are used in tandem with the projection lens to correct the distorted image profile into a rectangular form. However, this arrangement not only increases the difficulties of designing the projection lens, but also significantly increases the production cost as well.

### SUMMARY OF THE INVENTION

Accordingly, at least one objective of the present invention is to provide a rear projection display apparatus capable of solving the keystone-like distortion problem in the conventional offset projection technique.

At least another objective of the present invention is to provide a method for adjusting the image projected from a rear projection display apparatus so that keystone-like image distortion is removed.

To achieve these and other advantages and in accordance with the purpose of the invention, as embodied and broadly described herein, the invention provides a rear projection display apparatus. The rear projection display apparatus comprises an optical engine, a screen, a projection lens and a condensing element. The projection lens is disposed between the screen and the optical engine. The condensing element is disposed on the screen between the screen and the projection lens, and the center of condensing element is substantially offset from the center of the screen. The optical engine includes a light source and a display device. The light source is suitable for providing a light beam. The display device is disposed on the transmission path of the light beam for transforming the light beam into an image light beam. The projection lens is disposed on the transmission path of the image light beam and the position of the projection lens is offset from the center of the display device. The optical axis of the projection lens on the screen is offset from the optical axis of the condensing element. The display device has a common plane, and a normal vector of the common plane is not parallel to the optical axis of the projection lens.

The present invention also provides a method for adjusting the images projected from a rear projection display apparatus. In particular, the method is applicable to a rear projection display apparatus that uses the offset projection technique. The method for adjusting the image from the rear projection display apparatus includes the following steps. First, an optical engine and a projection lens of the rear projection display apparatus are simultaneously rotated a first angle toward the upper or the lower side of a screen. Then, a display device of the optical engine is rotated a second angle along the direction of rotation of the projection lens.

In the present invention, the optical engine and the projection lens of the rear projection display apparatus that deploys the offset projection technique are simultaneously rotated towards the upper and the lower edge of the screen. Thus, the location of the optical axis of the projection lens on the screen is offset from the center of the condensing element. As a result, the keystone-like image distortion problem in the conventional offset projection apparatus is reduced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A and 1B are diagrams showing the image-producing methods for two types of conventional rear projection display apparatus both using a non-offset projection technique.

FIGS. 2A and 2B are diagrams showing the image-producing methods for two types of conventional rear projection display apparatus both using an offset projection technique.

FIG. 3 is a diagram showing the picture frame from a rear projection display apparatus that uses the conventional offset projection technique.

FIGS. 4A through 4C show steps for adjusting the image from a rear projection display apparatus according to one embodiment of the present invention.

FIG. 5 is a diagram showing a structural layout of a rear projection display apparatus according to one embodiment of the present invention.

FIG. 6 is a diagram showing a structural layout of a rear projection display apparatus according to another embodiment of the present invention.

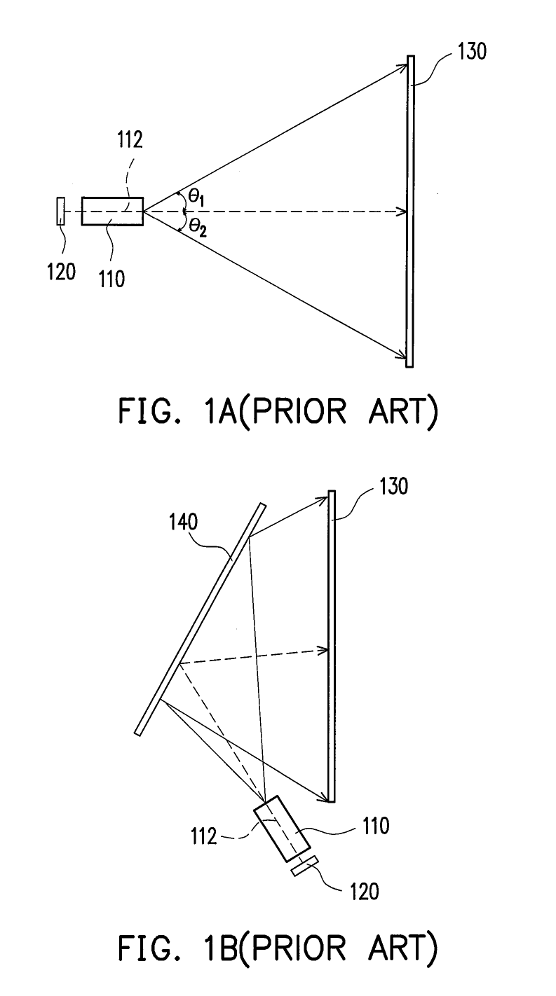

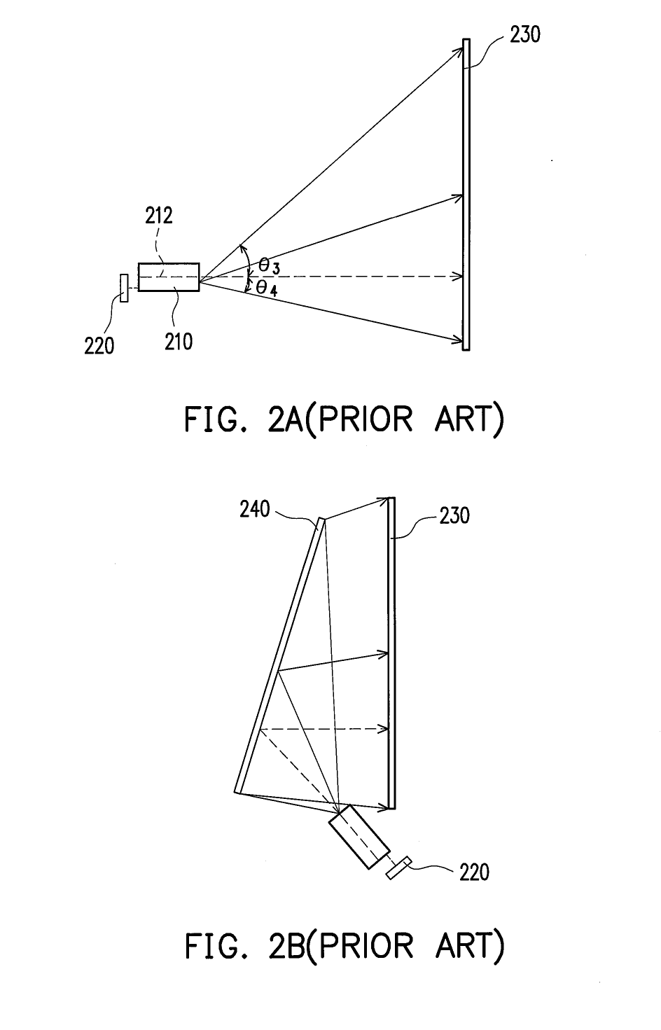

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

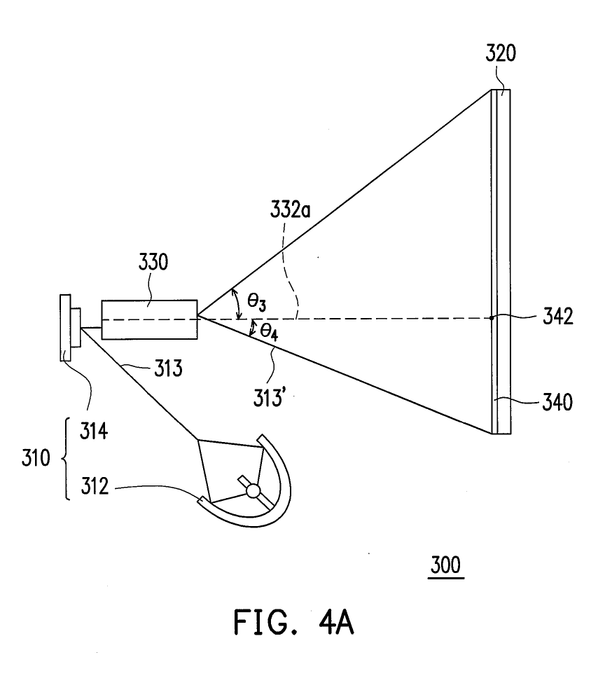

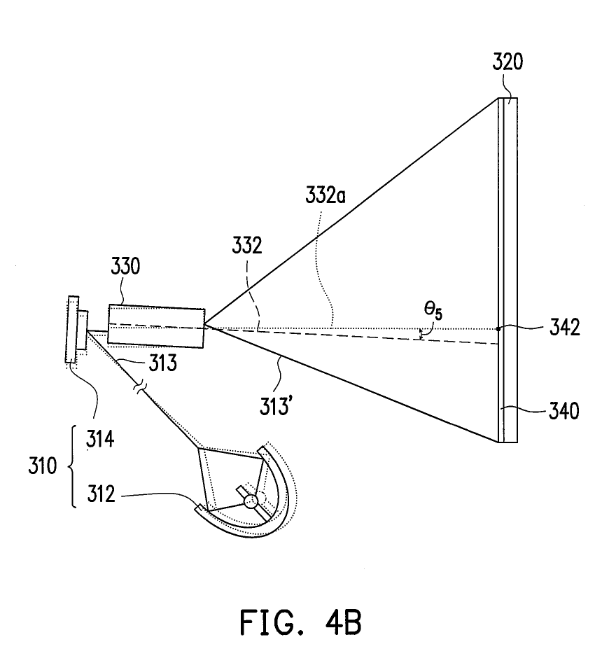

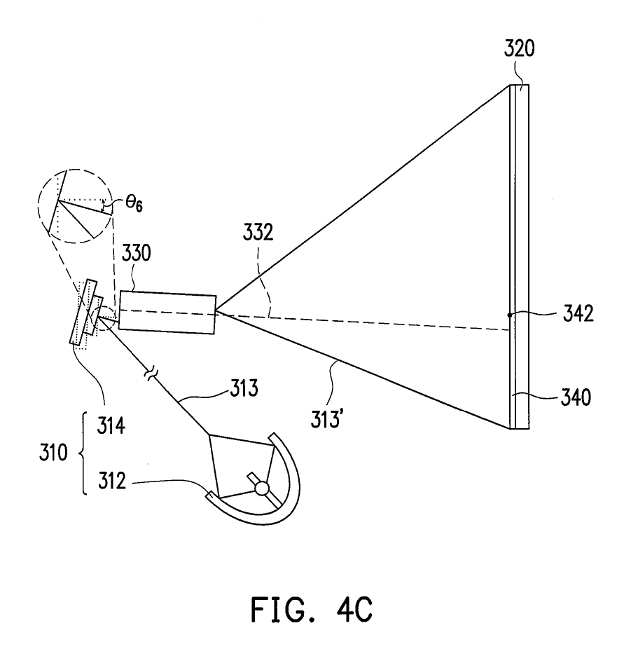

FIGS. 4A through 4C show the steps for adjusting the image from a rear projection display apparatus according to one embodiment of the present invention. First, as shown in FIG. 4A, the rear projection display apparatus 300 that uses an offset projection technique comprises an optical engine 310, a screen 320, a projection lens 330 and a condensing element 340. The projection lens 330 is disposed between the screen 320 and the optical engine 310. The condensing element 340 is disposed on the screen 320 and between the projection lens 330 and the screen 320. The optical engine 310 includes a light source 312 and a display device 314. The light source 312 is suitable for providing a light beam 313. The display device 314 is disposed on the transmission path of the light beam 313 so that the light beam 313 is transformed into an image light beam 313′. The projection lens 330 is disposed on the transmission path of the image light beam 313′. Moreover, the optical axis 332a of the projection lens 330 is offset from the center of the display device 314. The position of the optical axis 332a of the projection lens 330 on the screen 320 overlaps the center 342 of the condensing element 340. The condensing element 340 is a Fresnel lens, a holographic screen or a micro-prism screen, for example.

As shown in FIG. 4B, because the image displayed by the aforementioned rear projection display apparatus 300 has keystone-like distortion problem, the image adjusting method in the present invention is used to correct the image distortion. The image adjusting method includes rotating the projection lens 330 and the optical engine 310 a first angle θ₅ simultaneously towards the upper edge or the lower edge of the screen 320. Hence, the position of the optical axis 332 of the projection lens 330 on the screen 320 is offset from the center 342 of the condensing element 340. After rotating the first angle, the projector is shifted vertically so that the projected image is still located within the screen 320. For example, if the image displayed on the screen 320 is wider at the top than at the bottom before rotating the projection lens 330 and the optical engine 310, the projection lens 330 and the optical engine 310 are rotated toward the lower edge of the screen 320. Hence, the image profile displayed on the screen 320 comes closer to a rectangular shape. Afterwards, the entire projector is lifted up a little so that the projected image still falls within the range of the display screen 320. On the contrary, if the image displayed on the screen 320 is wider at the bottom than the top before rotating the projection lens 330 and the optical engine 310, the projection lens 330 and the optical engine 310 are rotated toward the upper edge of the screen 320. Hence, the image displayed on the screen 320 can have a rectangular or nearly rectangular shape. After that, the entire projector is lowered so that the projected image still falls within the range of the display screen 320.

As shown in FIG. 4C, both the projection lens 330 and the optical engine 310 rotate toward the upper side or the lower side of the screen 330 simultaneously so that the original image light beam 313′ projected on the focusing plane of the screen 320 is offset. Therefore, the angle between the display device 314 and the projection lens 330 needs to be adjusted so that the offset from the focusing surface is corrected. In the present invention, the angle between the display device 314 and the projection lens 330 is adjusted according to Scheimpflug theory. That is, by rotating the display device 314 a second angle θ₆ along the same direction as the projection lens 330, the junction between the extended surface of the common plane of the display device 314 and the extended surface of the screen 320 is located on the extended surface of the principle plane of the projection lens 330 so that the offset focus has shifted back to the focusing plane. As a result, the rear projection display apparatus 300 can provide a clearer image.

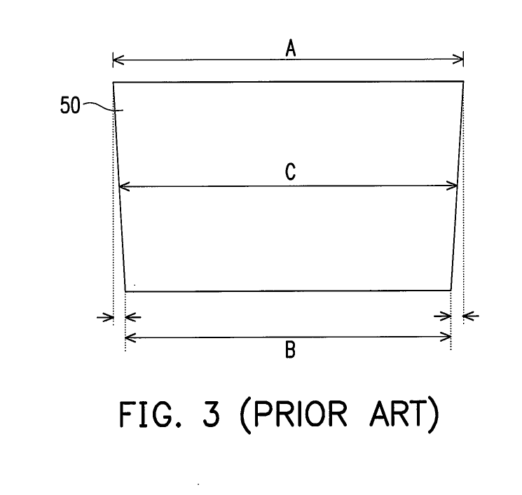

Using the rear projection display apparatus with offset projection shown in FIG. 4A as an example, the projection apparatus has a field of view θ₃ of 47.36° and θ₄ of 17.5°. The amount of deformation in the upper edge of the projected image (Du) is 0.0566%, and the amount of deformation in the lower edge of the projected image (Dd) is 1.18%. Because of the significant difference between the upper deformation and the lower deformation, the image has substantial keystone-like distortion. The upper deformation (Du) and the lower deformation (Dd) are defined with reference to FIG. 3. In fact, Du=(A−C)/C, Dd=(B−C)/C, where C is the central width of the image 50, A is the width at the uppermost edge of the image 50 and B is the width at the lowermost edge of the image 50. The image adjusting method in the present invention includes rotating both the projection lens 330 and the optical engine 310 simultaneously toward the lower edge of the screen 320 by a first angle θ₅, where θ₅ is 0.55° (as shown in FIG. 4B). Then, the display device 314 is rotated in the same direction as the projection lens 330 a second angle θ₆, where θ₆ is 0.01° (as shown in FIG. 4C). After the correction, the upper deformation (Du) is 0.565% and the lower deformation (Dd) is 0.557%. Hence, the upper deformation (Du) and the lower deformation (Dd) are corrected to a value close to each other. Consequently, the image profile is changed to a rectangular or near rectangular form and the keystone-like distortion often found in the display apparatus that uses the conventional offset projection technique is eliminated.

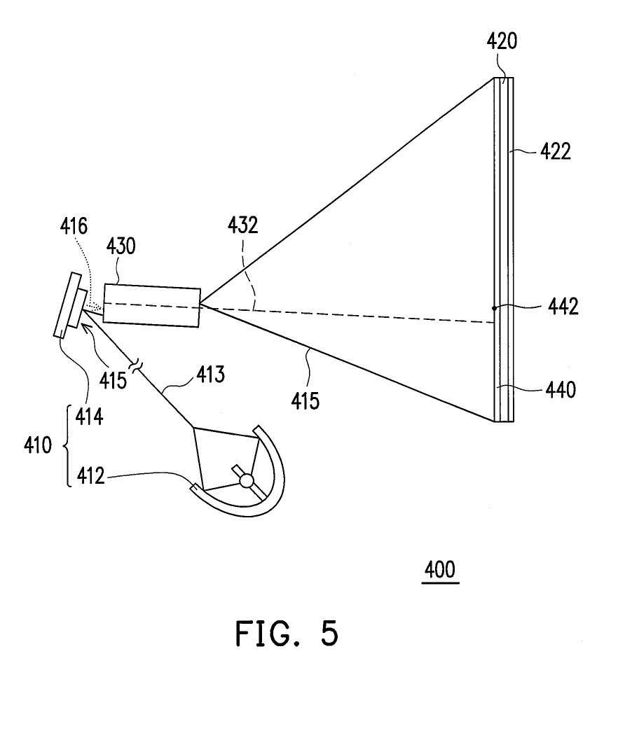

FIG. 5 is a diagram showing a structural layout of a rear projection display apparatus according to one embodiment of the present invention. After performing the foregoing steps to correct the image, the resulting structure of the rear projection display apparatus has a structure shown in FIG. 5. The rear projection display apparatus 400 includes an optical engine 410, a projection lens 430 and a condensing element 440. The projection lens 430 is disposed between the screen 420 and the optical engine 410. The condensing element 440 is disposed on the screen 420 between the projection lens 430 and the screen 420. The optical engine 410 includes a light source 412 and a display device 414. The light source 412 is suitable for providing a light beam 413. The display device 414 is disposed on the transmission path of the light beam 413 for transforming the light beam 413 to an image light beam 413′. The projection lens 430 is disposed on the transmission path of the image light beam 413′. Moreover, the optical axis 432 of the projection lens 430 is offset from the center of the display device 414. In addition, the location of the optical axis 432 of the projection lens 430 on the screen 420 is offset from the center of the condensing element 440. The display device 414 has a common plane 415, and a normal vector to the common plane 415 is not parallel to the optical axis 432 of the projection lens 430. Furthermore, the display device 414 is a digital micro-mirror device (DMD). The DMD includes a plurality of mirrors disposed as an array on the common plane. The condensing element 440 is a Fresnel lens, a holographic screen or a micro-prism screen, for example.

In the aforementioned rear projection display apparatus, the center 442 of the condensing element 440 is substantially offset from the center of the screen 420. In addition, the display device 414 is a transmissive panel (such as a transmissive liquid crystal display panel) other than the reflective panel (such as liquid crystal on silicon panel or digital micro-mirror device) as shown in FIG. 5. Furthermore, the screen 420 may include a light diffusion layer 422 disposed on a surface opposite to the condensing element 440 for dispersing the light beam. The light diffusion layer 422 has a lenticular lens structure or is fabricated using a light-dispersing material, for example.

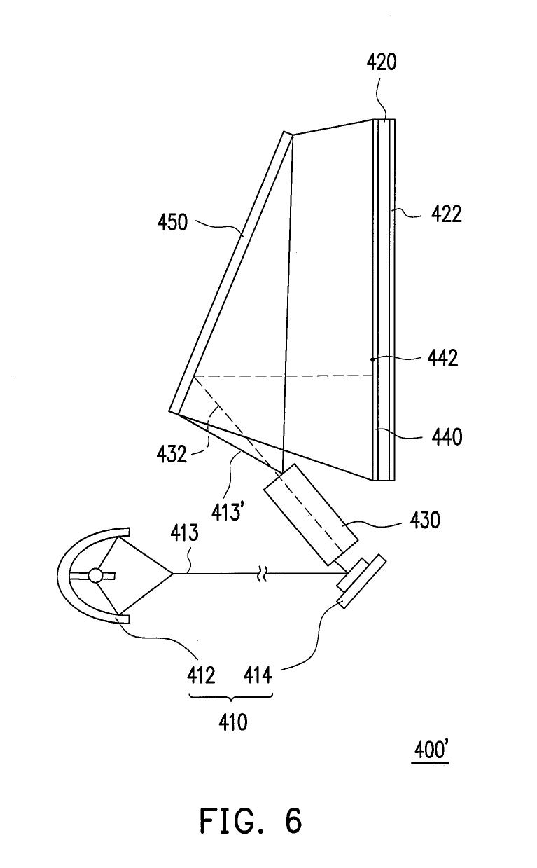

FIG. 6 is a diagram showing a structural layout of a rear projection display apparatus according to another embodiment of the present invention. Compared with the rear projection display apparatus 400 in FIG. 5, the rear projection display apparatus 400′ in FIG. 6 further includes a reflecting element 450 disposed between the projection lens 430 and the screen 420. Therefore, the image light beam 413′ projected from the projection lens 430 is reflected to the screen 420. The junction between the extended surface of the mirror image of the display device 414 and the extended surface of the screen 420 is located on the extended surface of the mirror image on the principle plane of the projection lens 430. In addition, the reflecting element 450 is a reflective plate or other element with good reflectivity.

In summary, the rear projection display apparatus and method of adjusting the image projected from the rear projection display apparatus according to the present invention has at least the following advantages:

1. The rear projection display apparatus in the present invention uses the offset projection technique so that the body thickness is reduced to match the current trend for a slimmer projector body.

2. By simultaneously rotating the projection lens and the optical engine toward the upper edge or the lower edge of the screen, the image profile is adjusted to a rectangular or near rectangular form. Hence, keystone-like distortion problem often found in a projection apparatus using the offset projection technique is eliminated.

3. There is no need to include many additional lenses inside the projection lens to correct the keystone-like distortion problem of a conventional display apparatus using the offset projection technique. Thus, overall production cost is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A rear projection display apparatus, comprising:
an optical engine, having:
a light source suitable for providing a light beam;
a display device disposed on the transmission path of the light beam for transforming the light beam into an image light beam;
a screen;
a projection lens disposed between the screen and the display device on the transmission path of the image light beam, wherein the optical axis of the projection lens is offset from the center of the display device; and
a condensing element disposed on the screen between the projection lens and the screen, wherein the center of the condensing element is substantially offset from the center of the screen,
wherein the position of the optical axis of the projection lens on the screen is offset from the center of the condensing element, and the display device has a common plane with a normal vector not parallel to the optical axis of the projection lens.

2. The rear projection display device of claim 1, wherein the condensing element includes a Fresnel lens, a holographic screen or a micro-prism screen.

3. The rear projection display apparatus of claim 1, wherein the junction between the extended surface of the display device and the extended surface of the screen is located at the extended surface of the principle plane of the projection lens.

4. The rear projection display apparatus of claim 1, further includes a reflecting element disposed between the projection lens and the screen for reflecting the image light beam projected from the projection lens to the screen.

5. The rear projection display apparatus of claim 4, wherein the junction between the extended surface of the mirror image on the display device and the extended surface of the screen is located on the extended surface of the mirror image on the principle plane of the projection lens.

6. The rear projection display apparatus of claim 4, wherein the reflecting element includes a reflective plate.

7. The rear projection display apparatus of claim 1, wherein the screen has a light diffusion layer disposed on a surface opposite to the condensing element.

8. The rear projection display apparatus of claim 7, wherein the light diffusion layer includes a lenticular lens structure.

9. The rear projection display apparatus of claim 1, wherein the display device includes a transmissive liquid crystal display panel, a reflective liquid crystal on silicon panel or a digital micro-mirror device.

10. An image adjusting method suitable for a rear projection display apparatus that uses an offset projection technique, the image adjusting method including:
simultaneously rotating an optical engine and a projection lens of the rear projection display apparatus towards the upper edge of a screen or the lower edge of the screen by a first angle and then, the optical axis of the projection lens on the screen being offset from the center of a condensing element set up on the screen; and
rotating a display device of the optical engine along the same direction of the rotation of the projection lens by a second angle.
